(19) United States
(12) Patent Application Publication
(10) Pub. No.: US 2023/0339485 A1
(43) Pub. Date: Oct. 26, 2023

(54) ONBOARD DATALINK VOLTAGE MONITORING FOR IMPROVED DIAGNOSTICS

(71) Applicant: International Engine Intellectual Property Cpmpany, LLC, Lisle, IL (US)

(72) Inventor: Mark Stephan Ehlers, Ft. Wayne, IN (US)

(73) Assignee: International Engine Intellectual Property Company, LLC, Lisle, IL (US)

(21) Appl. No.: 17/726,377

(22) Filed: Apr. 21, 2022

(51) Int. Cl. B60W 50/04; G06F 11/07

(52) U.S. Cl. CPC B60W 50/045; G06F 11/0739; G06F 11/079; B60W 2050/041

(57) ABSTRACT

The present disclosure relates to improved diagnostic devices, systems and methods for improving the accuracy and speed of diagnosing datalink/CAN errors on public and private networks within the electronic control systems of machines. The present disclosure includes incorporating one or more diagnostic modules to one or more datalinks within an existing electronic control system. These diagnostic modules can monitor datalink voltages and identify and transmit error messages and datalink voltage anomalies without the need for manual diagnosis by a repair technician. Alternatively, another diagnostic system and method includes installing microchips having datalink voltage measurements to existing modules, such as a telematics module, thereby enabling that the module to identify and report datalink voltage anomalies.

### TECHNICAL FIELD

The present disclosure relates to diagnostic devices, systems and methods for use in connection with the electronic control units (ECUs) connected to the datalinks, which are used in all forms of machinery, including heavy-duty vehicles, electric and hybrid vehicles, construction and agricultural equipment and machinery, stationary generators, to name a few. Specifically, the present disclosure relates to improved diagnostic devices, systems and methods for improving the accuracy and speed of diagnosing datalink/CAN errors by pinpointing errors in datalink voltages to find the root cause of datalink communication errors.

### BACKGROUND

Today's modern vehicles can have multiple electronic control units (ECU), which control every aspect of the vehicle, with the largest processer often being the engine control unit. Interconnection and communication between different vehicle subsystems and control units, including the telematics module, is accomplished using controller area network or CAN bus, which act as the “nervous system” of the vehicle. The CAN bus system enables each ECU to communicate with all other ECUs without complex dedicated wiring. Additionally, some sensors on the vehicle have their own CAN communication. Bus typically operates in accordance with a protocol such as the Society of Automotive Engineers (SAE) J1939 protocol relating to Controller Area Networks (CAN).

J1939 is an industry standard protocol providing for communications between Electronic Control Units (ECUs) over a Controller Area Network (CAN) bus. Diagnostic tools can also use the bus to monitor the data between ECUs and communicate with individual ECUs for troubleshooting, software updates, and programming. An ECU may be a module such as the Engine Control Module (ECM), or a sensor such as the Diesel Exhaust Fluid Tank Level and Temperature sensor (DEFTLT).

The J1939 datalink used in many vehicles uses two wires labeled High (H) and Low (L), twisted together at regular spacing to create an unshielded twisted pair (UTP). UTP wiring provides a high degree of immunity to electrical noise, which could interrupt communications. To further keep noise to a minimum, the total resistance between the H and L wires is specified at 60-ohms. This is accomplished by having two 120-ohm resistors, one near each end of the bus, between the H and L wires. The two 120-ohm resistors in parallel form a total resistance of 60-ohms. The resistor may be an external, separate item, or internal to an ECU. Together, the H and L wires form a communication bus. An ECU may have more than one bus. If the busses are independent, such as the Public and Private busses found in the ECM, a fault in one bus will not affect the other bus.

Any fault in a communication bus will result in some loss of communication between ECUs. This can include any of the following:

Short to ground, to voltage, or H and L wires shorted together will result in total loss of communication, with no EC s able to communicate.

Open anywhere along the bus will effectively result in two separate networks, with ECUs on one side of the break being unable to communicate with ECUs on the other side. If the break results in the disconnection of one of the terminating resistors, the ECUs still connected to each other may not be able to communicate with each other as well. ECUs on one side of the break will set faults indicating that messages from ECUs on the other side were not received.

Loss of power to an individual ECU will result only in that ECU not sending messages, and no other interruption will occur. Other ECUs ill set a fault indicating that messages from the ECU without power were not received.

Specifically, an ECU can prepare and broadcast information (e.g. sensor data) via the CAN bus, consisting of two wires, CAN low and CAN high. The broadcasted data is accepted by all other ECUs on the CAN network. Each ECU can then check the data and decide whether to receive or ignore it. These systems support various communication, safety and performance features in the vehicle.

CAN error diagnostic procedures are well-known in the industry. All vehicles and machinery in production today and in product planning utilize both private and public CAN datalinks that are prone to difficult to diagnose errors when any segment of the circuit experiences an open or short either in the circuit or inside a CAN module. Detection of breaks in the circuit are diagnosed through any number of fault codes, which may provide an initial indication of the error, but are not necessarily pinpointing the error.

Currently, the industry uses onboard monitors and software to identify and log datalink communication errors through a series of fault codes, which provide possible causes for the errors. A technician is then asked to inspect several areas for possible causes. In almost all cases the technician is instructed (via troubleshooting trees) to connect a voltmeter or communication cable and datalink analyzer software application to the suspect datalink, to monitor voltages and errors, wherein the technician then attempts to diagnose the problem. In some cases, an oscilloscope is used in the troubleshooting. However, this form of diagnosis takes time, may not always be accurate, and may lead to delays in the needed repair.

Therefore, a need exists for improved diagnostic devices, systems and methods for use in connection with the electronic control systems in machines incorporating datalinks. Specifically, a need exists for improving the accuracy and speed of diagnosing datalink/CAN errors on public and private networks of the electronic control system of machines.

A need further exists for improved diagnostic devices, systems and methods that provide another layer of diagnostic messages to lead a technician more quickly to the root cause of the datalink communication error.

A need also exists for improved diagnostic devices, systems and methods wherein CAN errors related to shorts and opens and high resistance and components on the datalink that are corrupting the communications, can be immediately identified and transmitted to an onboard controller, thereby obviating the need for checking and diagnosis by a repair technician.

### SUMMARY

The present disclosure relates to improved diagnostic devices, systems and methods for improving the accuracy and speed of diagnosing datalink/CAN errors on public and private networks within the electronic control systems incorporating datalinks used by a variety of machines. The present disclosure further includes incorporating one or more diagnostic modules to one or more datalinks within an existing control system, which can monitor datalink voltages and faults, and identify and transmit error messages and datalink voltage anomalies without the need for manual diagnosis by a repair technician. Alternatively, another diagnostic system and method includes adding datalink voltage measurements to an existing module, such as a telematics module, or multiple modules thereby enabling the module or modules to quickly identify and report datalink voltage anomalies or faults.

The present disclosure mentions “vehicles” generally as an example of machinery incorporating the present devices and systems. However, it should be understood that any machinery, not limited only to vehicles, which incorporate CAN datalinks can utilize the present devices and systems of diagnostics. Examples of such machinery include heavy-duty diesel trucks, electric and hybrid cars and trucks, agricultural and construction equipment and stationary generators.

To this end, in an embodiment of the present disclosure, a method of self-diagnosing errors within an electronic control system for a vehicle is provided. The method comprises the steps of providing a series of modules interconnected by datalinks creating an electronic control system within the vehicle, incorporating at least one diagnostic module capable of diagnosing errors within the datalinks connecting the series of modules, and automatically diagnosing errors within the datalinks through the diagnostic module.

In another embodiment, a diagnostic system for diagnosing controller area network errors in an electronic control system of a vehicle, is provided. The system comprises a series of modules interconnected by datalinks creating the electronic control system within the vehicle, at least one diagnostic module positioned within the series of modules, the diagnostic module capable of diagnosing errors within the datalinks, and wherein the diagnostic module transmits error messages to an onboard controller.

In yet another embodiment, a diagnostic system for diagnosing a controller area network errors in an electronic control system of a vehicle, is provided. The system comprises a series of modules interconnected by datalinks creating the electronic control system within the vehicle and a plurality of datalink voltage diagnostic measurements embedded into at least one of the modules, wherein the module can transmit datalink voltage faults and error messages to an onboard controller.

It is, therefore, an advantage and objective of the present disclosure to provide diagnostic devices, systems and methods for use in connection with the electronic control systems in a variety of machinery, including heavy duty vehicles, electric and hybrid vehicles, agricultural and construction equipment and other forms of machinery, such as generators. Specifically, the present disclosure provides devices and systems for improving the accuracy and speed of diagnosing datalink/CAN errors on public and private networks within the control system on a vehicle.

It is a further advantage and objective of the present disclosure to provide diagnostic devices, systems and methods wherein CAN errors related to shorts and opens can be immediately identified through a series of diagnostic messages sent to an onboard controller. In this way, a repair technician is not required to conduct manual checking/diagnosis as the present system provides another layer of diagnostic messages that lead more quickly to the root cause of the datalink communication error.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a schematic diagram of an example of a general electronic control system for a vehicle incorporating a diagnostic module of the present disclosure; and,

FIG. 2 illustrates an example of an existing module modified to incorporate datalink voltage measurement diagnostics according to the present disclosure.

### DETAILED DESCRIPTION

The present disclosure relates to improved diagnostic devices, systems and methods for improving the accuracy and speed of diagnosing datalink/CAN errors on public and private networks within the electronic control systems in machinery. The present devices, systems and methods are also useful in diagnosing a new category of datalink voltage faults within the controller area network interconnecting the various modules of the electronic control system. In the present disclosure, a separate module or modules incorporating the datalink voltage fault diagnostic measurements may be added to the electronic control system. Alternatively, an existing module or modules already within the system, such as a telematics module, can be modified to incorporate the datalink voltage fault diagnostic criteria. The improved diagnostic devices and systems of the present disclosure can be incorporated into any form of machinery utilizing CAN datalinks.

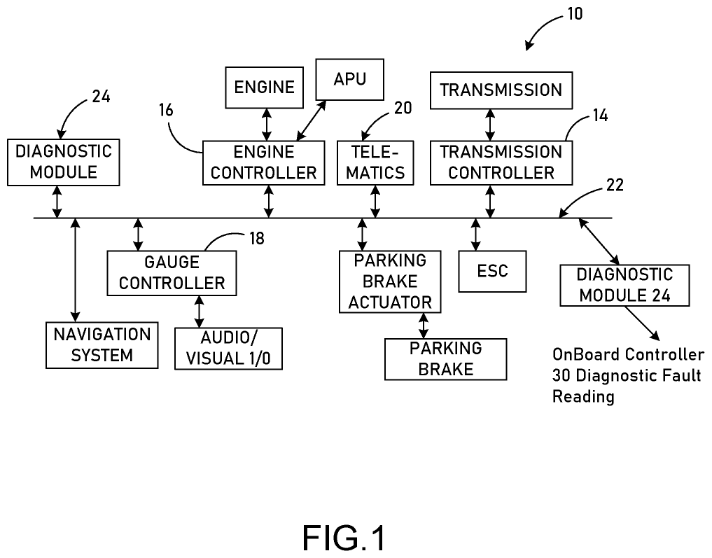

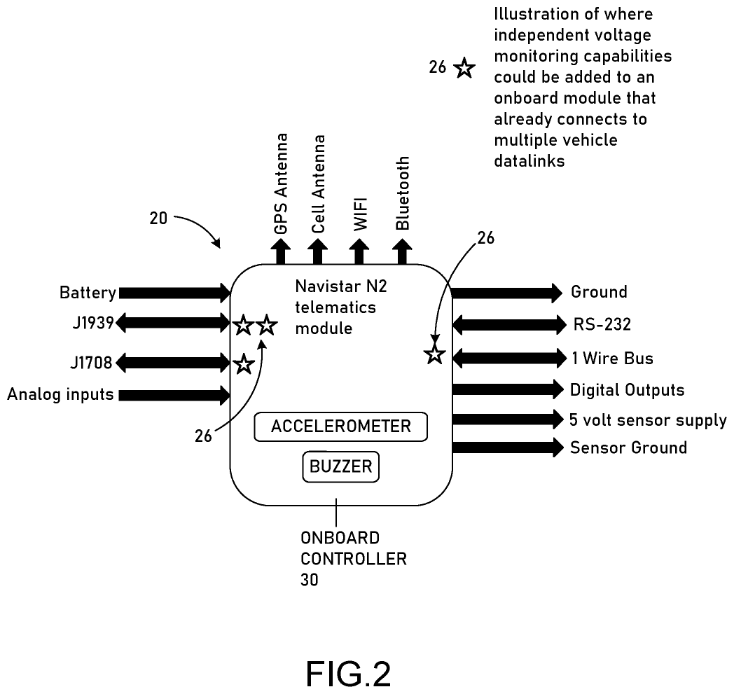

Now referring to the figures, wherein like numerals refer to like parts, FIG. 1 illustrates a schematic diagram of a general electronic control system for a vehicle incorporating a diagnostic module of the present disclosure. FIG. 2 illustrates a telematics module modified to include datalink voltage diagnostic measurements, wherein this module can identify, and then report datalink voltage anomalies as provided in the present disclosure.

FIG. 1 illustrates an example of a schematic for a general electronic control system 10 for a vehicle. The electronic control system 10 includes an electrical system controller (ESC) 12, or equivalent, which serves as a supervisory controller for the control system. The electronic control system 10 further includes a plurality of relatively autonomous modules, controllers, sensors or operators. These modules for a vehicle include, but are not limited to, the transmission controller 14, the engine controller 16, the gauge controller 18 and the telematics module 20. There may be any number and forms of generic, programmable modules, controllers, and/or sensors, which may be used to carry out operator defined tasks though they are not limited to such functions. Interconnection and communication between different subsystems and control units is accomplished using controller area network or CAN bus 22, which are a two-wire (CAN high and CAN low) connected pair permitting exchange of information between the control unit modules.

CAN datalinks 22 are prone to difficult-to-diagnose errors, when any segment of the circuit experiences an open or short, either in the circuit itself or inside a CAN module. Datalink communication errors between the modules or controllers is usually identified through onboard monitors and software, which log the errors. The errors are typically presented as industry standard fault codes, which are used by a technician to determine possible causes for the errors. The technician is then instructed to inspect several areas of the system based on the fault codes, i.e., troubleshoot the problem through connections to the suspect datalink and monitor voltages to attempt to create or recreate the symptom. This manual method of diagnosis is time-consuming and may not be accurate.

In addition, datalink voltages on the CAN bus have a standard range. For example, for engine diagnostics, a J1939-H pin and a known good ground typically have a voltage range of 2 to 4 volts. Because of this standard, datalink voltages are not typically monitored, and a diagnostic tool, such as a digital multimeter is required to measure the voltage between connector locations on the CAN bus. Again, this manual method of diagnosis is time-consuming and may not be accurate.

To overcome the inefficiencies of the methods used in the standard diagnosis of datalink/CAN errors within the electronic control system 10, it is proposed to add one or more diagnostic modules 24 to one or more datalinks 22 within the system (FIG. 1). These new diagnostic modules 24 would incorporate voltage measurement microchips and circuitry and therefore be designed to monitor and read datalink voltages. Additionally, the diagnostic module would transmit error or voltage fault messages on the CAN directly to an onboard controller 30, therefore automatically and accurately pinpointing the location of the datalink voltage fault within the CAN.

Another option for creating an improved diagnostic system, is to modify an existing module or modules within the electronic control system 10 with microchips or circuitry incorporating the diagnostic voltage fault measurements 26. For example, FIG. 2 illustrates a typical telematics module 20. As understood in the industry, the telematics module collects data including diagnostics information, vehicle speed, real-time location, driver information, etc., and transmits this information through cellular communication interfaces, Wi-Fi and Bluetooth to a cloud server. Among other uses, telematic modules are useful in the diagnosis of vehicle performance and notifies the vehicle occupant to any potential issues needing attention.

According to the present disclosure, the telematics module 20 would be modified to incorporate diagnostic voltage fault measurements 26. The telematics module 20 is now capable of diagnosing shorts and opens within the CAN bus, which are then immediately identified and transmitted to the onboard controller. Modification of the telematics module 20 in this manner enables an existing module within the control system 10 to transmit the datalink voltage anomalies to an onboard controller for immediate diagnosis of the problem, without the need for manual diagnosis by a repair technician. It should be understood that although the telematics module 20 is described, any existing module within the control system of any machine can be modified to include datalink voltage fault measurements, and therefore serve as a diagnostic module.

Reporting of the datalink or CAN errors, either through an additional diagnostic module 24 or through modification of an existing module, such as the telematics module 20 described above, provides another layer of diagnostic messages that can be sent immediately and directly to an onboard controller 30. It is advantageous to include new diagnostic datalink voltage fault messages, so that the technician can immediately determine the source of the fault and provide a more immediate repair, either without the need for further extensive manual diagnosis, or at least limited further manual diagnosis. New diagnostic fault messages, which would be projected onto an onboard controller 30 may include:
“CAN high open for XX seconds”
“CAN low open for XX seconds”
“CAN high shorted to ground for XX seconds”
   and many others. Each fault message contains the time and freezeframe data that is collected per industry standards, like engine faults for example. The addition of the new diagnostic modules 24 or modification of existing modules, such as a telematics module 20 with the datalink voltage fault measurements 26, bypasses the need for manual diagnosis of the errors. The present disclosure provides diagnostic messages that lead a repair technician more quickly to the root cause of the datalink communication error. The advantage is that vehicles and machinery equipped with this enhanced self-diagnostic capability can be diagnosed and repaired more quickly.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A method of self-diagnosing errors within an electronic control system for a machine, the method comprising the steps of:
providing a series of modules interconnected by datalinks creating the electronic control system within the machine;
incorporating at least one diagnostic module within the series of modules, the diagnostic module capable of diagnosing errors within the datalinks; and
automatically diagnosing errors within the datalinks through the diagnostic module.

2. The method of claim 1, wherein at least one sensor may be incorporated within the series of modules.

3. The method of claim 2, wherein the method further includes monitoring datalink voltages for datalink voltage faults.

4. The method of claim 3, wherein the method further includes transmitting any datalink voltage faults from the diagnostic module to an onboard controller.

5. The method of claim 4, wherein the method further includes displaying the datalink voltage faults as diagnostic fault messages on the onboard controller.

6. The method of claim 5, wherein the diagnostic fault messages provide self-diagnostic readings within the electronic control system.

7. The method of claim 1, wherein the method further includes modifying at least one of the modules with datalink voltage measurements.

8. The method of claim 7, wherein the modules containing the datalink voltage measurements can identify and reporting datalink voltage anomalies to the onboard controller.

9. The method of claim 8, wherein the datalink voltage anomalies provide a self-diagnostic fault reading.

10. A diagnostic system for diagnosing a controller area network errors in an electronic control system of a vehicle, the system comprising:
a series of modules interconnected by datalinks creating the electronic control system within the vehicle;
at least one diagnostic module positioned within the series of modules, the diagnostic module capable of diagnosing errors within the datalinks; and
wherein the diagnostic module can transmit error messages to an onboard controller.

11. The diagnostic system of claim 10, wherein the diagnostic module can identify anomalies in the datalink voltage measurements.

12. The diagnostic system of claim 11, wherein the anomalies in the datalink voltage measurement are transmitted as a diagnostic fault to the onboard controller.

13. The diagnostic system of claim 12, wherein the onboard controller displays the diagnostic fault as a message.

14. The diagnostic system of claim 13, wherein the diagnostic fault contains a time and data point for diagnosis of the anomalies.

15. The diagnostic system of claim 14, wherein the diagnostic fault message enables self-diagnosis of the controller area network errors.

16. A diagnostic system for diagnosing a controller area network errors in an electronic control system of a machine, the system comprising:
a series of modules interconnected by datalinks creating the electronic control system within the machine;
a plurality of datalink voltage diagnostic measurements embedded into at least one of the modules, wherein the module can transmit datalink error messages to an onboard controller.

17. The diagnostic system of claim 16 wherein the series of modules includes a telematics module.

18. The diagnostic system of claim 17, wherein the telematics module includes a plurality of datalink voltage measurements built into the telematics module.

19. The diagnostic system of claim 18, wherein the telematics module can identify anomalies in the datalink voltage measurements.

20. The diagnostic system of claim 19, wherein the anomalies in the datalink voltage measurement are transmitted as a diagnostic fault to the onboard controller
